(19) United States
(12) Patent Application Publication
(10) Pub. No.: US 2012/0185858 A1
(43) Pub. Date: Jul. 19, 2012

(54) PROCESSOR OPERATION MONITORING SYSTEM AND MONITORING METHOD THEREOF

(75) Inventors: Naoya OHNISHI, Tokyo (JP); Hiroshi Nakatani, Tokyo (JP); Yoshito Sameda, Kanagawa-ken (JP); Jun Takehara, Tokyo (JP); Atsushi Inoue, Tokyo (JP); Makoto Toko, Saitama-ken (JP)

(73) Assignee: KABUSHIKI KAISHA TOSHIBA, Tokyo (JP)

(21) Appl. No.: 13/349,710

(22) Filed: Jan. 13, 2012

(30) Foreign Application Priority Data
Jan. 19, 2011 (JP) P2011-008983

(51) Int. Cl. G06F 9/46

(52) U.S. Cl. 718/100

(57) ABSTRACT

A processor includes a computation unit; a storage unit storing a program; and a data transmission circuit that transmits to an operation monitoring unit a signal corresponding to an instruction for reporting the execution stage of the program. The operation monitoring unit: includes a transition operation identification. circuit and a loop processing identification circuit. The transition operation identification circuit receives a start ID instruction with an attached ID that identifies a task; a termination ID instruction that identifies termination of task operation; and if the task is execution of loop processing, a loop instruction that reports the maximum value of the number of times of this loop processing. The transition operation identification circuit identifies success of the transition operations of the tasks of the program, based on the ID instructions. The loop processing identification circuit identifies abnormality of the number of times of loop processing.

### CROSS-REFERENCE TO RELATED APPLICATION

This application claims benefit of priority from Japanese application number JP 2011-8983 filed Jan. 19, 2011, the entire contents of which are incorporated by reference herein.

### FIELD

Embodiments described herein relate generally to a processor monitoring system for monitoring the operating condition of a program executed by a processor, and to a method of monitoring thereof.

### BACKGROUND

Processor fault detection typically involves monitoring abnormalities of operation using a watchdog timer. However, apart from program bugs, hacking and software errors etc, processor faults may be caused by faults of the various constituent elements of the processor circuitry.

In recent years, in safety devices such as control devices in which a high degree of safety is required, an operation monitoring function is demanded that is capable of verifying correct operation of the device in which the processor is provided.

Accordingly, the method has been disclosed of monitoring the sequence of operation of a program that is being executed by a processor during system operation, and successively examining state transitions by constructing a “state machine” in an operation monitoring device external to the processor, in order to detect stoppage of processor operation or to detect erroneous operation (malfunction). Examples are disclosed in Published Japanese Patent Number 4359632, which is an issued patent in Japan (hereinafter referred to as Patent Reference 1), or Laid-open Japanese Patent Application 2010-9296, which is likewise an issued patent in Japan (hereinafter referred to as Patent Reference 2).

However, the microprocessor operation monitoring system disclosed in Patent Reference 1 incorporates in the operation monitoring circuit a state machine circuit for simulating beforehand the program that is being executed, by using reconstructable hardware such as an FPGA (field programmable gate array): since the new state that the processor ought to take must be calculated, the construction of this operation monitoring circuit becomes complicated.

Also, since the simulating circuit must be altered every time the program is altered, there is the problem that, in a system in which program alteration is anticipated, maintenance becomes complicated and time-consuming.

Also, in the case of the software operation monitoring device disclosed in Patent Reference 2, a construction is adopted in which hardware is used to monitor whether or not the task start-up sequence is normal, using the currently started-up task ID and the ID of the previous task that was started up previously, by allocating an identification information ID containing information specifying the current task and the previously executed task to tasks that are started up, in correspondence with the task address. The information obtained as a result of this monitoring is stored in the form of a time sequence as log information. However, this makes the circuit construction complicated.

Furthermore, the required memory capacity becomes large due to the fact that a construction is adopted whereby abnormalities of the software execution condition are ascertained by the watchdog timer and the stored log information is saved to a recording unit when timeout of the watchdog timer is detected.

There are therefore the problems that, depending on the method of task transition, it is possible that the executed software may be slowed down by the large number of IDs or that a considerable time is required to stop the system once abnormality has been detected.

Thus, in a safety control system using a processor that is required to have safety and reliability, although it is desirable that the circuitry should be constructed so as to detect abnormality of program operation, or incorrect program operation with few errors, in the case of the construction of Patent Reference 2, there are the problems that complex circuitry and large memory capacity become necessary.

According to an aspect of the present technology, a processor operation monitoring system and method for monitoring thereof are provided whereby it is possible to rapidly detect abnormality of the task start-up sequence of the processor, with a straightforward circuit and small memory capacity, without requiring reconstruction of the operation monitoring unit when the program is altered.

A processor operation monitoring system according to the present invention is constructed as follows. Specifically, a processor operation monitoring system comprising: a processor; and an operation monitoring unit that monitors the operation thereof is characterized in that: aforementioned processor comprises a computation unit that executes aforementioned program; a storage unit that stores aforementioned program constituted by a plurality of tasks; and a data transmission circuit that transmits to aforementioned operation monitoring unit a bit signal corresponding to instructions reporting the execution condition of aforementioned program by aforementioned computation unit; and

aforementioned operation monitoring unit comprises a transition operation identification circuit that monitors the transition state of aforementioned program; and a looping processing identification circuit that ascertains the number of times of looping of a looping process and

respective aforementioned tasks comprise:

a start ID instruction that attaches beforehand an ID identifying aforementioned task constituting a transition source to the start address of the task in question;

a termination ID instruction that identifies termination of operation of the task in question at the final address of the task in question and, if the task in question executes loop processing, a loop instruction that reports the maximum value of the number of times of this looping processing

and aforementioned computation unit or aforementioned data transmission circuit respectively generates: aforementioned start ID bit signal corresponding to aforementioned start ID instruction and uses this as a state signal capable of identifying the transition source task from other tasks when this task is started up, in respect of all of the tasks constituting aforementioned program; aforementioned termination ID bit signal corresponding to aforementioned termination ID instruction and uses this as a state signal capable of identifying the fact that another task is not started up when the task in question terminates, in respect of all of the tasks constituting aforementioned program; and a maximum value signal corresponding to aforementioned loop instruction; and transmits these from aforementioned data transmission circuit to aforementioned operation monitoring unit;

aforementioned transition operation identification circuit finds a coincidence signal of a first termination ID bit signal produced when operation was terminated and a second start ID bit signal of aforementioned task that is next to be started up, and the exclusive OR of aforementioned coincidence signal and aforementioned second start ID bit signal, and uses these to evaluate success of the transition operations of the tasks of aforementioned program; and

aforementioned loop processing identification circuit counts, as an increment signal, a coincidence signal of the first start ID bit signal at which operation was started and the first termination ID bit signal, and identifies abnormality of the number of times of loop processing by comparing this count value and aforementioned maximum value, so that abnormality of the transition operations of the tasks can be detected during the execution of the program by the processor.

In order to achieve the above object, a method of monitoring in a processor operation monitoring system according to the present invention comprises the following steps. Specifically, a method of monitoring the operation of a processor comprising a processor and an operation monitoring unit that monitors the operation thereof comprises: a step of, in respect of all of the tasks constituting a program, setting up beforehand a start ID instruction that attaches an ID identifying aforementioned task constituting the transition source at the start address of the task in question; a termination ID instruction that identifies termination of operation of the task in question at the final address of the task in question; and, if the task in question executes loop processing, a loop instruction that reports the maximum value of the number of times of this loop processing;

a step of respectively generating: aforementioned start ID bit signal corresponding to aforementioned start ID instruction and using this as a state signal capable of identifying the transition source task from other tasks when this task is started up, in respect of all of the tasks constituting aforementioned program; aforementioned termination ID bit signal corresponding to aforementioned termination ID instruction and using this as a state signal capable of identifying the fact that another task is not started up when the task in question terminates, in respect of all of the tasks constituting aforementioned program; and a maximum value signal corresponding to aforementioned loop instruction;

a step of finding a coincidence signal of a first termination ID bit signal produced when operation was terminated and a second start ID bit signal of aforementioned task that is next to be started up, and the exclusive OR of aforementioned coincidence signal and aforementioned second start ID bit signal, and using these to evaluate success of the transition operations of the tasks of aforementioned program; and

a step wherein aforementioned loop processing identification circuit counts, as an increment signal, a coincidence signal of the first start ID bit signal at which operation was started and the first termination ID bit signal, and identifies abnormality of the number of times of loop processing by comparing this count value and aforementioned maximum value.

With the present invention, a processor operation monitoring system and method of monitoring thereof can be provided that are capable of easily detecting abnormality of the task start-up sequence of the processor by straightforward circuitry and small memory capacity, without requiring reconstruction of the operation monitoring unit when the program is altered.

### BRIEF DESCRIPTION OF THE DRAWINGS

FIG. 1 is a layout diagram of a processor operation monitoring system according to Embodiment 1 of the present invention;

FIG. 2 is an example of a program comprising a plurality of tasks;

FIG. 3A and FIG. 3B are diagrams illustrating the layout of tasks and the associated start ID instruction and termination ID instruction, and the corresponding start ID bit signal and termination ID bit signal, according to the present invention;

FIG. 4 is a circuit layout diagram of a transition operation identification circuit;

FIG. 5 is a view given in explanation of the operation of the transition identification circuit;

FIG. 6A, FIG. 6B and FIG. 6C are views given in explanation of the operation of a loop processing identification circuit; and

FIG. 7 is a layout diagram of a processor operation monitoring system according to Embodiment 2 of the present invention.

### DETAILED DESCRIPTION

Embodiments are described below with reference to the drawings.

### Embodiment 1

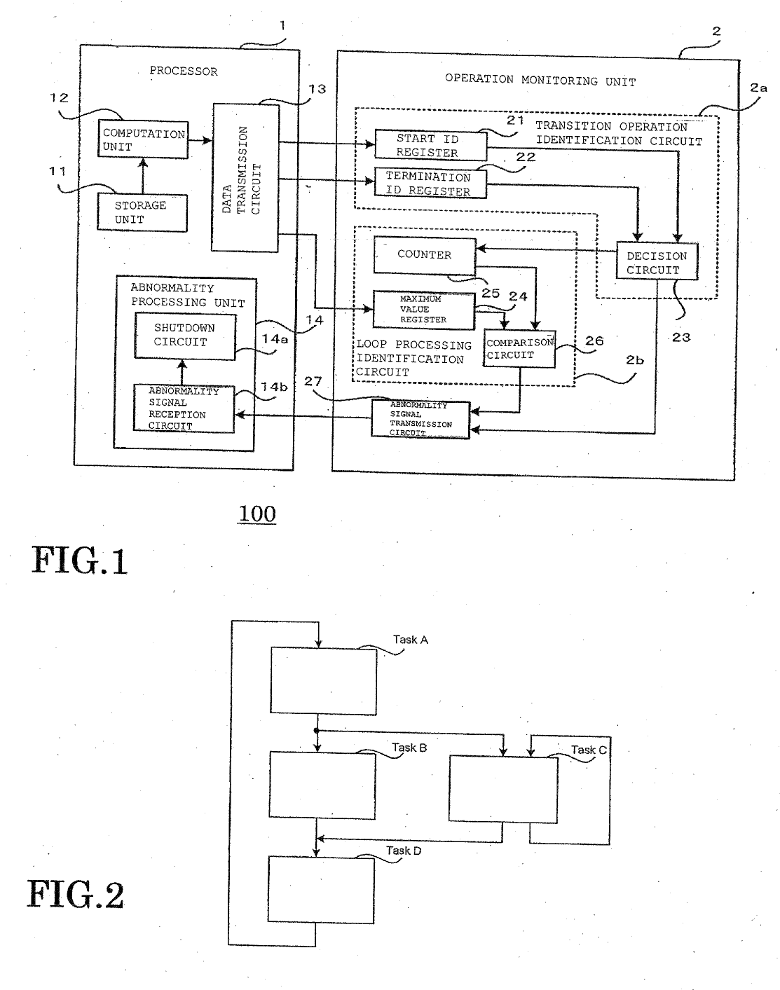

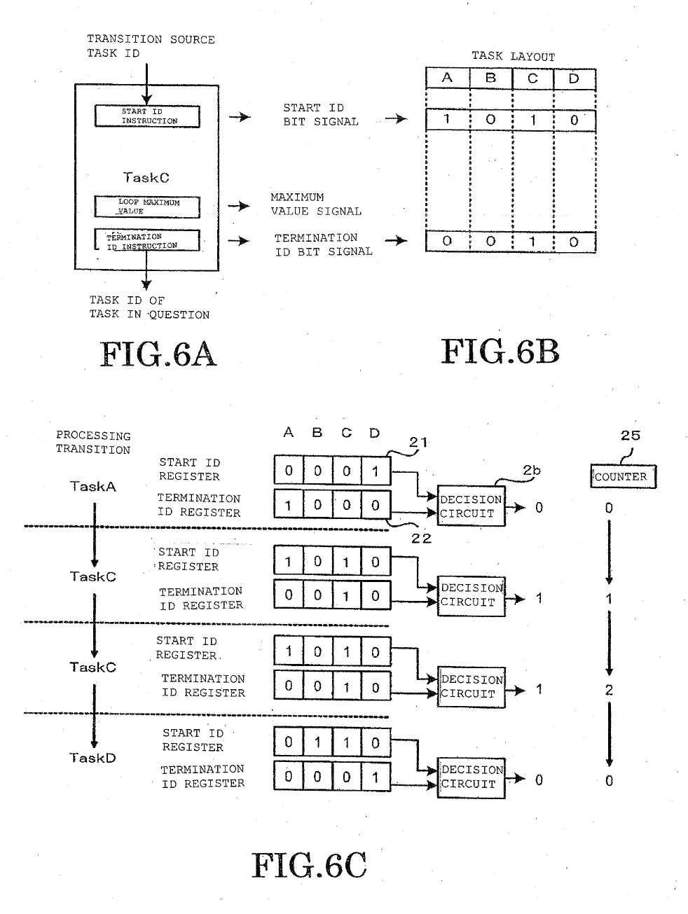

Hereinafter, Embodiment 1 will be described with reference to FIG. 1 to FIG. 6A, FIG. 6B and FIG. 6C. First of all, the construction of this embodiment will be described with reference to FIG. 1. The “processor” as referred to herein is a general term meaning the CPU (central processing unit) or MPU (micro processing unit) constituting the central processing unit of the microcomputer, irrespective of the mode of mounting thereof.

A processor operation monitoring system 100 comprises a processor 1 and an operation monitoring unit 2 that monitors the operation of the processor 1.

The processor 1 comprises a computation unit 12 that executes a program, a storage unit 11 that stores the program, comprising a plurality of tasks, and a data transmission circuit 13 that transmits to the operation monitoring unit 2 a bit signal corresponding to an instruction whereby the computation unit 12 notifies the execution state of the program.

The operation monitoring unit 2 comprises a transition operation identification circuit 2a that monitors the transition condition of the program and a loop processing identification circuit 2b that identifies abnormality in relation to the number of times of looping of loop processing.

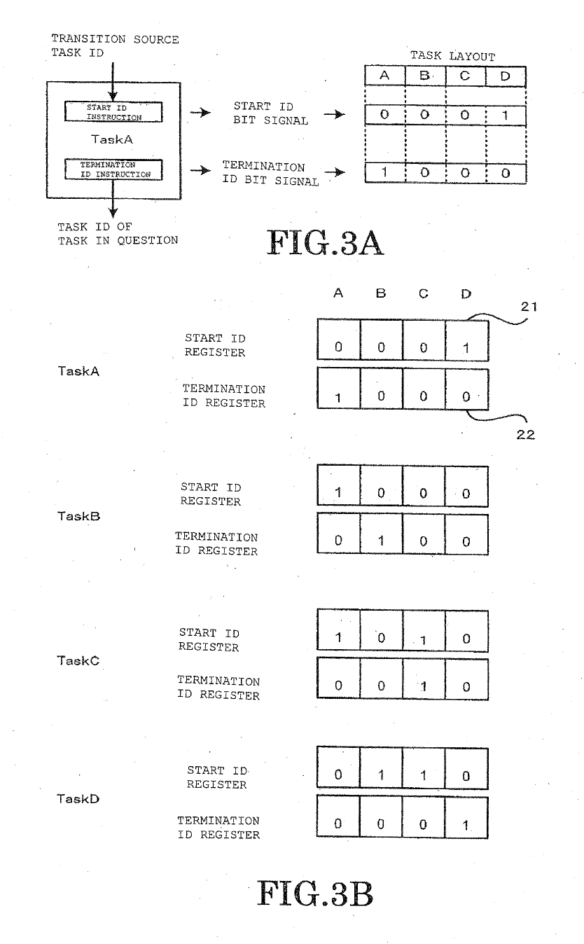

Next, the detailed construction of the various units will be described. First of all, the constituent tasks of the program in question will be described with reference to FIG. 2, FIG. 3A and FIG. 3B. FIG. 2 is a diagram showing an example of the start-up sequence of the tasks (Task A to Task D). Also, FIG. 3A and FIG. 3B are diagrams showing the start ID instruction that is attached to a task in accordance with such a start-up sequence, the start ID bit signal corresponding to the start ID instruction, the termination ID instruction, and the termination ID bit signal corresponding to this termination ID instruction.

As shown in FIG. 3A, in task A, the start ID instruction is attached to the start address thereof. These start ID bit signals are used to identify the location of the transition source tasks. The start ID bit signals corresponding to this start ID instruction are generated as for example a bit signal “0001” corresponding to the tasks A to D, as task A→0, task B→0, task C→0, task D→1, and transmitted to the transition operation identification circuit 2a from the data transmission circuit 13.

This bit signal “0001” shows that the transition source of the task A is the task D.

Also, in the case where more than one task constitutes a transition source, for example in the case of task C, we have “1010”, indicating that the transition sources are task A and the current task i.e. task C.

Also, in the case of task C, in which loop processing is performed, as shown in FIG. 6A, the maximum value of the number of times of execution of this loop is an internal variable of the task C in question and the value thereof is entered beforehand and delivered to the loop processing identification circuit 2B from the data transmission circuit 13.

Specifically, the respective tasks compromise: a start ID instruction that attaches an ID identifying the task constituting the transition source to the start address of the task in question beforehand; a termination ID instruction that identifies the termination of operation of the task in question at the final address of the task in question; and, if the task in question executes loop processing, a loop instruction that notifies the maximum value of the number of times of loop processing. The computation unit 12 or the data transmission circuit 13 respectively generates: as the start ID bit signal corresponding to the start ID instruction, for all the tasks constituting the program, a state signal whereby it is possible to identify a task constituting a transition source when this task is started up and other tasks; as the termination ID bit signal corresponding to the termination ID instruction, a state signal whereby it is possible to identify, for all the tasks constituting the program, the other tasks that are not started up when this task terminates; and a final value signal corresponding to the loop instruction; and transmits these from the data transmission circuit 13 to the operation monitoring unit 2.

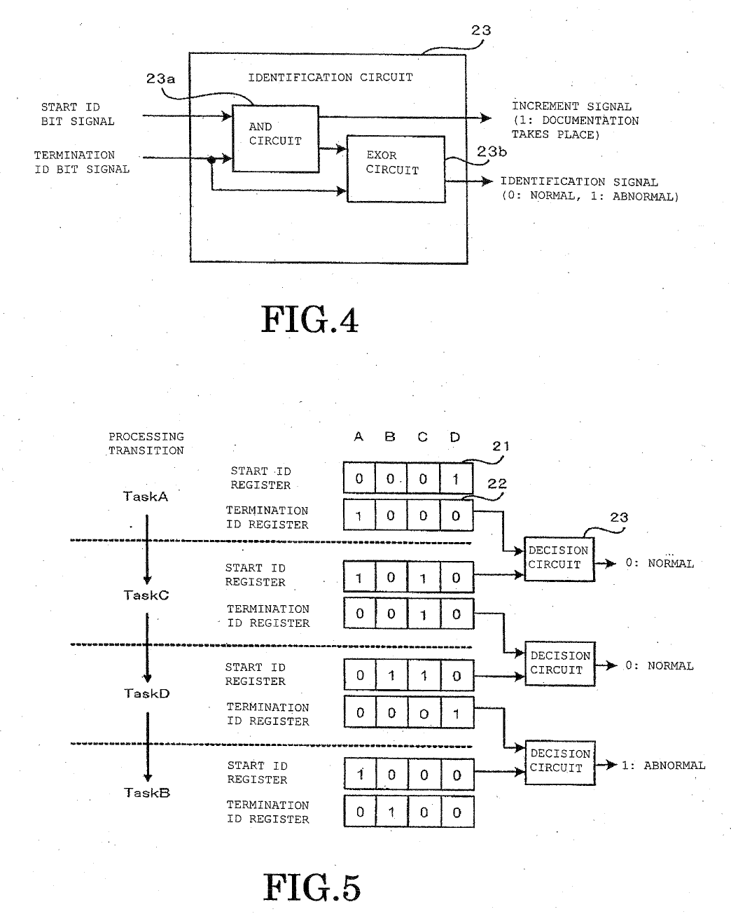

Next, the detailed layout of the transition operation identification circuit 2 will be described referring to FIG. 1 and FIG. 4.

The transition operation identification circuit 2 comprises a termination ID register 21 and start ID register 22 that temporarily store the termination ID bit signal and start ID bit signal. In addition, as shown in FIG. 4, the transition operation identification circuit 2 comprises an identification circuit 23 provided with: a first AND circuit 23a and an EXOR circuit 23b; the first AND circuit 23a finds logical coincidence of the output of the termination ID register 22 and the start ID register 21, with the timing of receipt of the start ID bit signal of the task; the EXOR circuit 23b finds the exclusive OR of the output of the AND circuit 23a and the aforementioned start ID bit signal.

Next, the operation of the transition operation identification circuit 2a constructed in this way will be described with reference to FIG. 2 and FIG. 5. FIG. 5 shows the tasks in respect of the program of FIG. 2, comprising a start ID instruction and termination ID instruction that store the preset transition operations: the operation of the identification circuit 23 and when the transition operations of task A→task C→task D→task B take place will now be described.

First of all, a preset value “0001” is written as the initial value of the start ID register of task A. Then, with the timing with which the start ID register signal indicating transition from task A to task C is received, the bit signals corresponding to the respective tasks represented by the termination register value “1000” of task A and the start ID register value “1010” of the task C are logically identified by the AND circuit 23a and the EXOR circuit 23b, and the fact that the situation is normal is identified by the fact that the output obtained is “0000”.

However, on transition from task D to task B, the output of the EXOR circuit 23B becomes “0001”, which is identified as abnormality of the task D.

Specifically, although, in this embodiment, there are a plurality of transition sources (start conditions), as shown by the case of the transition from task C to task D, abnormality of the transition operation can be instantaneously identified by the preset bit information after writing to the start ID register.

Next, the layout of loop decision processing 2b will be described with reference to FIG. 6A, FIG. 6B and FIG. 6C. The principle of operation thereof is that whether or not the loop processing of the task has been performed less than the preset number of times of looping is ascertained by counting, as an increment signal, logical coincidence of the respective bit signals written to the start ID register and start termination register and comparing, at the timing with which the termination ID bit signal of the task in question is received, the count value of the task in question and the looping maximum value written in a maximum value register from this task.

Logical coincidence of the respective bit signals written in the start ID register and start termination register is treated as an increment signal of the number of times of looping; the output of the AND circuit 23a provided in the identification circuit 23 of the transition operation identification circuit 2a is branched thereat and counted by input to the counter 25. A decision is then made as to whether or not the number of times of looping is abnormal by using the comparison circuit 26 to compare the output of this counter 25 and the maximum value written to the maximum value register 24; if the decision output of the transition operation identification circuit 2a was also abnormal, this is transmitted to the abnormality processing unit 14 from the abnormality signal transmission circuit 27.

Regarding the abnormality processing unit 14, although this was stated to be of a construction mounted on the processor 1, its construction could be independent of both the processor 1 and the operation monitoring unit 2, or it could be attached to either of these.

This abnormality decision output could be used to shut down the processor 1 by a request to the system with which the processor 1 is provided, or could be utilized for diagnosis by logging the abnormality data.

As described above, with Embodiment 1, the transition information of the program is written to the respective tasks and an evaluation is made as to whether or not the transition was successful, based on the bit information of all of the tasks corresponding to the instructions, on execution of these instructions; the transition states of all of the tasks being detailed beforehand as their start ID instruction and termination ID instruction. Consequently, a processor operation monitoring system can be provided whereby abnormality can be evaluated at the timing instant of commencement of the task by a simple circuit construction, using the success of the task transition operation as the minimum information for this purpose.

### Embodiment 2

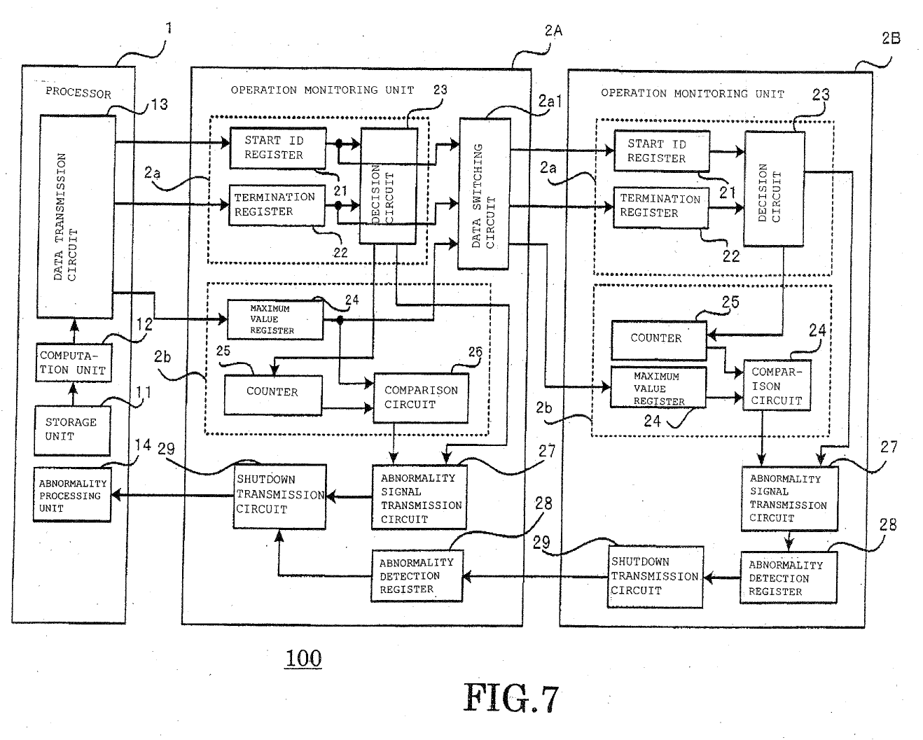

Next, the processor operation monitoring system of Embodiment 2 will be described with reference to FIG. 7. Items in Embodiment 2 that are the same as in Embodiment 1 shown in FIG. 1 are given the same reference symbols and further description is dispensed with.

As shown in FIG. 7, the difference between Embodiment 2 and Embodiment 1 lies in that whereas in the construction of Embodiment 1 a processor system A comprising a processor 1(A) and operation monitoring unit 2(A) was constituted on a single substrate, in the case of Embodiment 2, the operation monitoring unit 2B is provided on a different substrate B.

In more detail, in the operation monitoring unit 2A, there is provided a data switching circuit 2a1 that transmits a start ID bit signal, termination ID bit signal and a signal with maximum value, transmission being effected from this data switching circuit 2a1 to the operation monitoring unit 2B.

With Embodiment 2, the operation monitoring unit 2 can be embodied in redundant fashion: alternatively, if the system B is a processor system, a redundant arrangement can be constituted in which mutual diagnosis is performed by providing similar operation monitoring units, with the system B being diagnosed by the system A.

In this case, in the operation monitoring unit 2B, the data switching circuit 2a1 that is provided in the operation monitoring section 2A is provided, and the operation monitoring units are made to be compatible units having the same construction. Thus the system A shown in FIG. 7 and the similar system B have the same construction, so that a redundant configuration can be constituted in which these perform mutual diagnosis.

While various embodiments of the present invention have been described, these embodiments are presented by way of example only, and are not intended to restrict the scope of the invention. Novel embodiments could be implemented in various other modes and various omissions, replacements and alterations could be effected without departing from the scope of the invention. Such embodiments or modifications are included in the gist of the invention and are included in the range of equivalents to the invention as set out in the patent claims.

What is claimed is:

1. A processor operation monitoring system comprising:
(1) a processor; and
(2) an operation monitoring unit that monitors an operation thereof, wherein:
(1) said processor comprises
(i) a computation unit that executes a program;
(ii) a storage unit that stores said program constituted by a plurality of tasks; and
(iii) a data transmission circuit that transmits to said operation monitoring unit a bit signal corresponding to instructions reporting an execution condition of said program by said computation unit; and
(2) said operation monitoring unit comprises
(i) a transition operation identification circuit that monitors a transition state of said program; and
(ii) a looping processing identification circuit that ascertains a number of times of looping of a looping process and respective said tasks comprise:
a start ID instruction that attaches beforehand an ID identifying said task constituting a transition source to the start address of said task in question;
a termination ID instruction that identifies termination of operation of said task in question at a final address of said task in question; and
a loop instruction that reports a maximum value of a number of times of said looping processing, if said task in question executes loop processing, and
said computation unit or said data transmission circuit respectively generates: said start ID bit signal corresponding to said start ID instruction and uses this as a state signal capable of identifying a transition source task from other tasks when said task is started up, in respect of all of said tasks constituting said program; said termination ID bit signal corresponding to said termination ID instruction and uses this as a state signal capable of identifying a fact that another task is not started up when said task in question terminates, in respect of all of said tasks constituting said program; and a maximum value signal corresponding to said loop instruction; and transmits these from said data transmission circuit to said operation monitoring unit;
(i) said transition operation identification circuit finds a coincidence signal of said termination ID bit signal produced when operation was terminated and a second start ID bit signal of said task that is next to be started up, and an exclusive OR of said coincidence signal and said second start ID bit signal, and uses these to evaluate success of transition operations of the tasks of said program; and
(ii) said loop processing identification circuit counts, as an increment signal, a coincidence signal of a first start ID bit signal at which operation was started and a first termination ID bit signal, and identifies abnormality of number of times of loop processing by comparing a count value and said maximum value, so that abnormality of transition operations of said tasks can be detected during an execution of said program by said processor.

2. The processor operation monitoring system according to claim 1,
wherein said transition operation identification circuit comprises:
a termination ID register and start ID register that temporarily store said termination ID bit signal and said start ID bit signal respectively;
a first AND circuit that finds, with a timing of receipt of said start ID bit signal of said task, logical coincidence of an output of said termination ID register and said start ID register; and
an EXOR circuit that finds an exclusive OR of said AND circuit output and said start ID bit signal.

3. A processor operation monitoring system according to claim 1,
wherein said loop processing identification circuit comprises a termination ID register, a start ID register and a maximum value register that temporarily store said termination ID bit signal, said start ID bit signal and a maximum value signal respectively;
a second AND circuit that finds, every time said termination ID bit signal is received, a coincidence signal of an output of said termination ID register and said termination register;
a counter that counts using an output of said AND circuit as an increment signal; and
a comparison circuit that compares a count value of said counter and said maximum value.

4. The processor operation monitoring system according to claim 3,
wherein said second AND circuit is arranged to generate said increment signal from said output of said first AND circuit.

5. A method of monitoring operation of a processor having a processor and an operation monitoring unit that monitors an operation thereof comprising:
in respect of all of tasks constituting a program, setting up beforehand a start ID instruction that attaches an ID identifying said task constituting a transition source at a start address of a task in question, a termination ID instruction that identifies termination of operation of said task in question at a final address of said task in question; and, if said task in question executes loop processing, a loop instruction that reports a maximum value of number of times of said loop processing;
respectively generating: said start ID bit signal corresponding to said start ID instruction and using this as a state signal capable of identifying a transition source task from other tasks when this task is started up, in respect of all of tasks constituting said program; said termination ID bit signal corresponding to said termination ID instruction and using this as a state signal capable of identifying a fact that another task is not started up when said task in question terminates, in respect of all of tasks constituting said program; and a maximum value signal corresponding to said loop instruction;
finding a coincidence signal of a first termination ID bit signal produced when operation was terminated and a second start ID bit signal of said task that is next to be started up, and an exclusive OR of said coincidence signal and said second start ID bit signal, and using these to evaluate success of transition operations of said tasks of said program; and
a step wherein said loop processing identification circuit counts, as an increment signal, a coincidence signal of a first start ID bit signal at which operation was started and said first termination ID bit signal, and identifies abnormality of number of times of loop processing by comparing this count value and said maximum value.
